(19) United States
(12) Patent Application Publication
(10) Pub. No.: US 2011/0001724 A1
(43) Pub. Date: Jan. 6, 2011

(54) COMMUNICATION TERMINAL FOR PERFORMING ELECTRIC FIELD COMMUNICATION AND METHOD FOR OPERATING THE SAME

(75) Inventors: Hee Chan CHOI, Suwon-si (KR); Hyung Tae Kim, Seoul (KR)

Correspondence Address: THE FARRELL LAW FIRM, LLP, 290 Broadhollow Road, Suite 210E, Melville, NY, 11747, US

(73) Assignee: Samsung Electronics Co., Ltd., Gyeonggi-do (KR)

(21) Appl. No.: 12/828,904

(22) Filed: Jul. 1, 2010

(30) Foreign Application Priority Data
Jul. 1, 2009 (KR) 10-2009-0059626

(51) Int. Cl. G06F 3/045

(52) U.S. Cl. 345/174

(57) ABSTRACT

An electric field communication terminal and a method for operating it are disclosed. Since the communication terminal according to the present invention includes a plurality of signal electrodes, it can perform electric field communication without contacting the user's body, which provides use convenience. In addition, since the plurality of signal electrodes can serve as an input unit, such as a touch screen, the user can efficiently use the communication terminal.

### PRIORITY

This application claims priority under 35 U.S.C. §119(a) to an application filed in the Korean Patent Office on Jul. 1, 2009 and assigned Ser. No. 10-2009-0059626, the contents of which are incorporated herein by reference.

### BACKGROUND OF THE INVENTION

1. Field of the Invention

The present invention relates generally to communication systems, and more particularly, to a communication terminal for performing electric field communication and a method for operating the communication terminal.

2. Description of the Related Art

A communication system generally includes communication terminals that communicate and share information with each other, such as a mobile phone and a laptop computer. A particular communication method is used to share information between communication terminals when they are located within a short range of each other.

Conventional communication methods include wired and wireless communication. Wired communication refers to the transfer of information using physical connecting means such as a cable, and has an advantage in that communication terminals can exchange information with each other at a high speed. A disadvantage of wired communication is that the user must directly connect the communication terminals to each other using a connection means and must inconveniently carry the connection means. Wireless communication refers to the transfer of information using electromagnetic waves based on communication technology, such as Bluetooth® and ZigBee®, and has an advantage in that communication terminals can be easily connected to each other. A disadvantage of wireless communication is that the communication speed is relatively low.

In order to overcome the aforementioned disadvantages, electric field communication is proposed, in which a communication path is formed via a conductive medium, such as a human body, and communication terminals may communicate with each other via the formed communication path. If a communication terminal contacts the human body, it can be electrically connected to the human body.

However, conventional communication terminals must inconveniently contact the user's body to perform electric field communication. That is, when the conventional communication terminals contact the user's body, they cannot properly perform electric field communication. For example, if a communication terminal is within a user's bag, it cannot perform electric field communication.

### SUMMARY OF THE INVENTION

The present invention has been made in view of the above problems, and provides a communication terminal that can perform electric field communication irrespective of whether it contacts a user's body.

The present invention further provides a method for operating the communication terminal that can perform electric field communication irrespective of whether it contacts a user's body.

In accordance with an embodiment of the present invention, provided is a method for operating an electric field communication terminal, including measuring, when a touch occurs on a screen in a general operation mode, the communication strength of a plurality of signal electrodes located at an area around the screen to perform electric field communication, analyzing the measured communication strength and detecting a touch coordinate on the screen, and performing a touch function of the detected touch coordinate on the screen.

In accordance with another embodiment of the present invention, provided is a communication terminal including a display unit for displaying a screen, a plurality of signal electrodes located at an area around the screen for performing electric field communication, a communication strength measuring unit for measuring the communication strength of the signal electrodes when a touch occurs on the screen in a general operation mode, a touch coordinate detecting unit for analyzing the measured communication strength and detecting a touch coordinate on the screen, and a controller for performing a touch function of the detected touch coordinate on the screen.

### BRIEF DESCRIPTION OF THE DRAWINGS

The features and advantages of the present invention will become more apparent from the following detailed description in conjunction with the accompanying drawings, in which:

FIG. 1 illustrates a configuration of an electric field communication system according to an embodiment of the present invention;

FIG. 2A illustrates the front side of the communication terminal according to an embodiment of the present invention;

FIG. 2B illustrates the rear side of the communication terminal shown in FIG. 2A;

FIG. 3 is a block diagram illustrating a communication terminal according to an embodiment of the present invention;

FIG. 4A illustrates an first example of an electric field communication unit shown in FIG. 3;

FIG. 4B illustrates a second example of an electric field communication unit shown in FIG. 3;

FIG. 5 describes a method for operating a communication terminal, according to an embodiment of the present invention; and

FIG. 6 illustrates a communication terminal in order to explain the method for operating the communication according to an embodiment of the present invention.

### DETAILED DESCRIPTION OF EMBODIMENTS OF THE INVENTION

Hereinafter, embodiments of the present invention are described in detail with reference to the accompanying drawings. The same reference numbers are used throughout the drawings to refer to the same or similar parts. Detailed descriptions of well-known functions and structures incorporated herein may be omitted for the sake of clarity and conciseness.

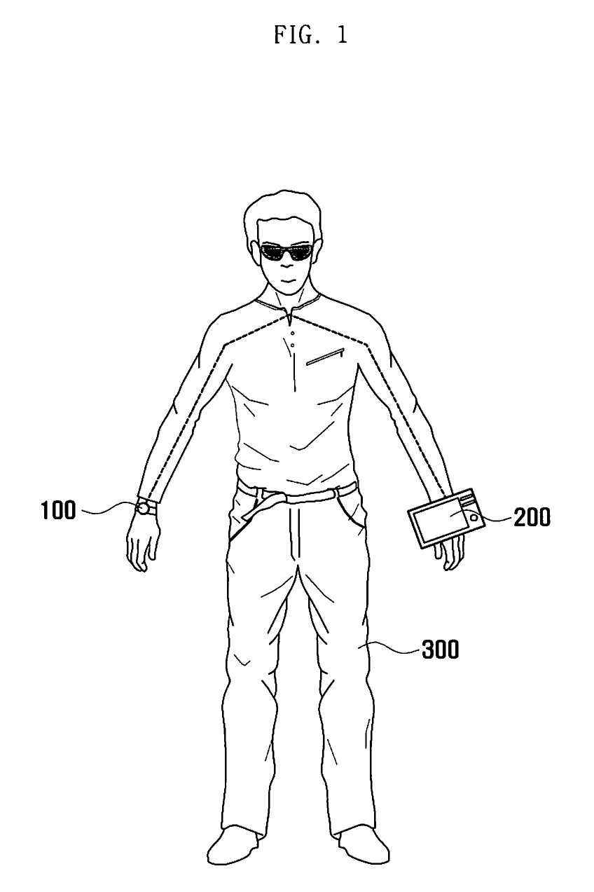

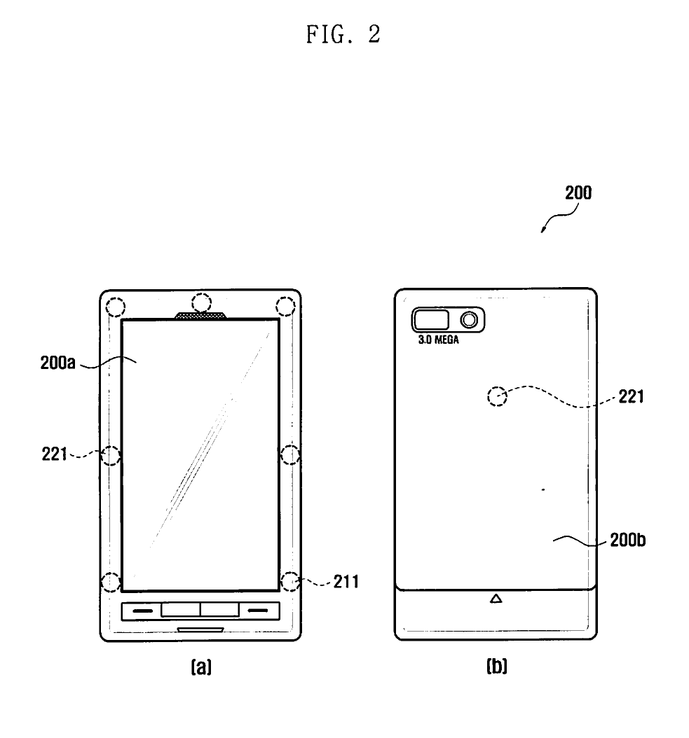

FIG. 1 illustrates a configuration of an electric field communication system according to an embodiment of the present invention. FIG. 2A and FIG. 2B illustrate the front and rear sides of the communication terminal according to an embodiment of the present invention.

Referring to FIG. 1, the electric field communication system includes communication terminals 100 and 200 and the human body 300 as a conductor. The communication terminals 100 and 200 are connected to each other via the human body 300 serving as a conductive medium and perform electric field communication. That is, the communication terminals 100 and 200 establish a communication path therebetween via the human body 300 and exchange information therethrough. In the present embodiment, the communication terminals 100 and 200 can perform electric field communication within a range of electric field formed by the human body 300. That is, the communication terminals 100 and 200 contact the human body 300 to perform electric field communication. Alternatively, the communication terminals 100 and 200 can also perform electric field communication even if they do not contact the human body 300.

As shown in FIGS. 2A and 2B, the communication terminal 200 may be a mobile phone. In that case, the communication terminal 200 is equipped with a plurality of signal electrodes 221, such as at least one signal electrode 221 on its front side 220a as shown in FIG. 2A and at least one signal electrode 221 on its rear side 220b as shown in FIG. 2B. The communication terminal 200 selects one of the signal electrodes 221 according to communication strength by signal electrodes 221 and performs electric field communication. The communication strength may be the Received Signal Strength Indicator (RSSI) of the signal electrodes 221.

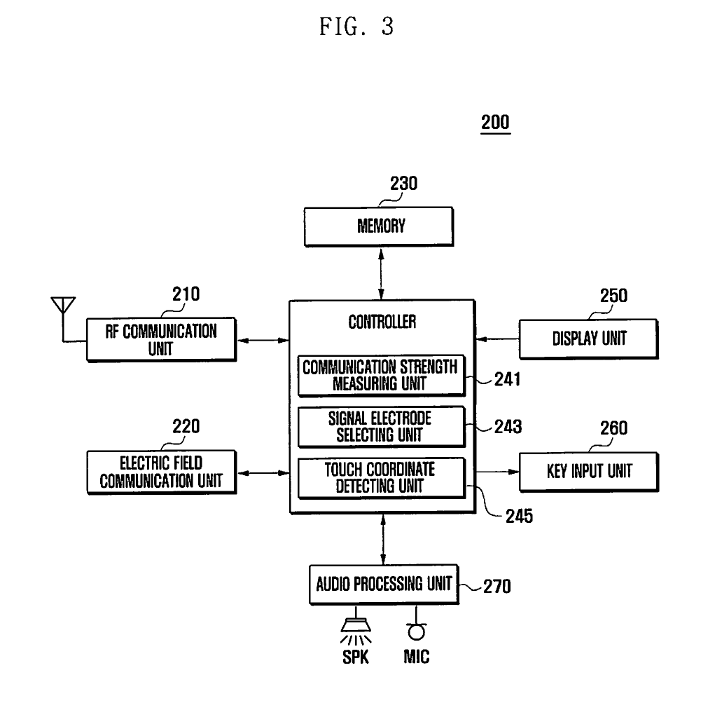

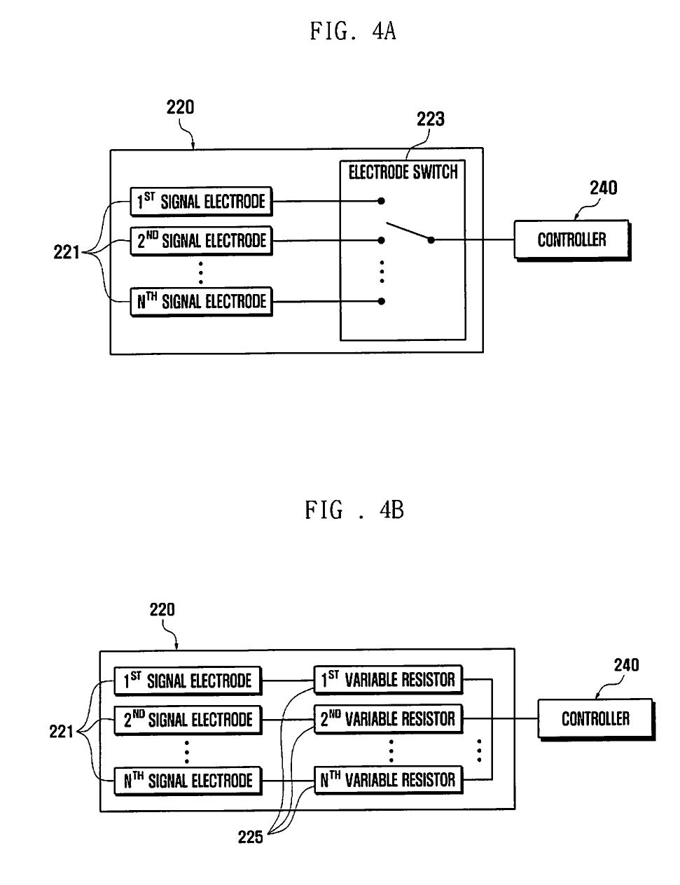

FIG. 3 illustrates a communication terminal according to an embodiment of the present invention. FIG. 4A illustrates a first example of an electric field communication unit shown in FIG. 3. FIG. 4B illustrates a second example of an electric field communication unit shown in FIG. 3. In the present invention, it is assumed that the communication terminal is a mobile phone.

Referring to FIG. 3, the communication terminal 200 includes a Radio Frequency (RF) communication unit 210, an electric field communication unit 220, a memory 230, a controller 240, a display unit 250, a key input unit 260, and an audio processing unit 270.

The RF communication unit 210 performs a wireless communication function of the communication terminal 200, and transmits and receives signals via an antenna.

The electric field communication unit 220 performs an electric field communication function. The electric field communication unit 220 is equipped with a plurality of signal electrodes 221 that are dispersed and located at a variety of positions in the communication terminal 200. The signal electrodes 221 are located at the area around the screen, and are made of a conductive material having high conductivity and are located on the external case of the communication terminal 200, which is made of insulating material having low conductivity. The electric field communication unit 220 transmits and receives signals via one of the plurality of signal electrodes 221.

The electric field communication unit 220 may be configured to include N signal electrodes 221 (where N is a positive integer) and a switch 223 as shown in FIG. 4A. When the switch 223 performs a connecting operation with respect to a corresponding signal electrode 221, a signal can be transmitted via the corresponding signal electrode 221. Alternatively, the electric field communication unit 220 may be configured to include N signal electrodes 221 and N variable resisters 225, as shown in FIG. 4B. The variable resisters 225 may be set to have different resistances. When the signal electrodes 221 receive a signal with a certain magnitude of communication strength, the respective variable resisters 225 can adjust the communication strength of the signal using their resistance.

The memory 230 includes a program memory and a data memory. The program memory stores application programs for controlling the functions of the communication terminal 200. The program memory can store application programs for controlling the operations of the plurality of signal electrodes 221. The data memory stores data generated when the application programs are executed. The memory 230 can also previously store positions of the signal electrodes 221.

The controller 240 controls the overall operation of the communication terminal 200. The controller 240 may further include a data processor that includes a transmitter for coding and modulating signals to be transmitted and a receiver for demodulating and decoding received signals. The data processor can be configured to include a modem and a codec. The codec includes a data codec for processing packet data, and an audio codec for processing audio signals such as voice signals.

The controller 240 can execute a general operation mode and a human body communication mode using the signal electrodes 221. That is, the controller 240 uses a signal, received via a signal electrode 221, as a touch signal in a general operation mode. In that case, the controller 240 uses at least one of the signal electrodes 221 as a transmitting electrode to perform signal transmission, and the remaining signal electrodes as receiving electrodes to perform signal reception.

For example, as shown in FIG. 2A, the signal electrodes 221, located at the front side 200a of the communication terminal 200, are used as transmitting electrodes. Likewise, as show 2B, the signal electrode 221 located at the rear side 200b is used as a receiving electrode. The signals to be transmitted via the transmitting electrodes can be received by the receiving electrode via the human body 300. After that, the controller 240 performs electric field communication, using the signal electrodes 221, in a human communication mode. For example, the controller 240 may be implemented with CMC755 chip, which is a type of chip that is capable of being implemented as the controller in the present invention. The controller 240 includes a communication strength measuring unit 241, a signal electrode selecting unit 243, and a touch coordinate detecting unit 245.

The communication strength measuring unit 241 measures the communication strength of the signal electrodes 221 in the general operation mode and the human communication mode. That is, the communication strength measuring unit 241 measures received signal strength indicators of signals received by the signal electrodes 221. The communication strength measuring unit 241 may measure the RSSIs at a preset frame period. The communication strength measuring unit 241 can previously set frames including time slots having a number the same as the number of signal electrodes 221, where the frames are respectively allocated to the signal electrodes 221.

For example, if the electric field communication unit 220 is configured as shown in FIG. 4A, the communication strength measuring unit 241 is connected, via the switch 223, to the signal electrodes 221, according to the time slots, at a preset frame period, and measures the communication strength. Likewise, if the electric field communication unit 220 is configured as shown in FIG. 4B, the communication strength measuring unit 241 detects signals of the signal electrodes 221 and measures the communication strength of the signals. The communication strength measuring unit 241 may apply corresponding resistances to the communication strength of the signals of the signal electrodes 221.

The signal electrode selecting unit 243 selects at least three of the signal electrodes 221 in the general operation mode and compares the communication strength of the selected signal electrodes 221. After that, the signal electrode selecting unit 243 selects the signal electrodes 221 according to the highest order of communication strength, so that they can be used to detect touch coordinates. Alternatively, the signal electrode selecting unit 243 selects at least one of the signal electrodes 221 in the human body communication mode. The signal electrode selecting unit 243 compares the communication strength of the signal electrodes 221, and selects one signal electrode 221 having the highest communication strength, to be used to perform electric field communication.

The touch coordinate detecting unit 245 detects touch coordinates on the screen in the general operation mode, by analyzing the communication strength of the signal electrodes 221. The touch coordinate detecting unit 245 may detect touch coordinates in trigonometry, by identifying positions of the signal electrodes 221. For example, if the electric field communication unit 220 is configured as shown in FIG. 4A, the touch coordinate detecting unit 245 can identify the positions of the signal electrodes 221 according to the time slots. Likewise, if the electric field communication unit 220 is configured as shown in FIG. 4B, the touch coordinate detecting unit 245 can identify the positions of the signal electrodes 221 according to the communication strength, by previously setting a range of communication strength of the signal electrodes 221 within which the touch coordinates can be detected. The range of the communication strength of the signal electrodes 221 can be selected according to the resistance. The touch coordinate detecting unit 245 can calculate the distance between the touch coordinate and the signal electrode 221 according to the communication strength. The touch coordinate detecting unit 245 can detect the touch coordinate in a range where the touch coordinate and the distance between the signal electrodes 221 overlap.

The controller 240 can measure the communication strength of signal electrodes 221, in the general operation mode and in the human body communication mode, via the communication strength measuring unit 241. The controller 240 selects one of the signal electrodes 221, via the signal electrode selecting unit 243, in the human body communication mode, and performs electric field communication through the selected signal electrode 221. The controller 240 selects at least three of the signal electrodes 221, via the signal electrode selecting unit 243, in the general operation mode, detects touch coordinates on the screen, via the touch coordinate detecting unit 245, in trigonometry for example, and then performs a touch function.

The display unit 250 displays user data output from the controller 240 on its screen. The display unit 250 may be implemented with a Liquid Crystal Display (LCD). In that case, the display unit 250 may further include an LCD controller, a memory for storing video data, and an LCD device.

The key input unit 260 includes a plurality of keys for receiving numerical and alphabetical information and function keys for setting a variety of functions. The key input unit 260 may further include a key for switching a general operation mode to a human body communication mode, and vice versa.

The audio processing unit 270 reproduces audio signals, output from the audio codec of the data processor, via a SPeaKer SPK or transfers audio signals, input via a MICrophone MIC, to the audio codec.

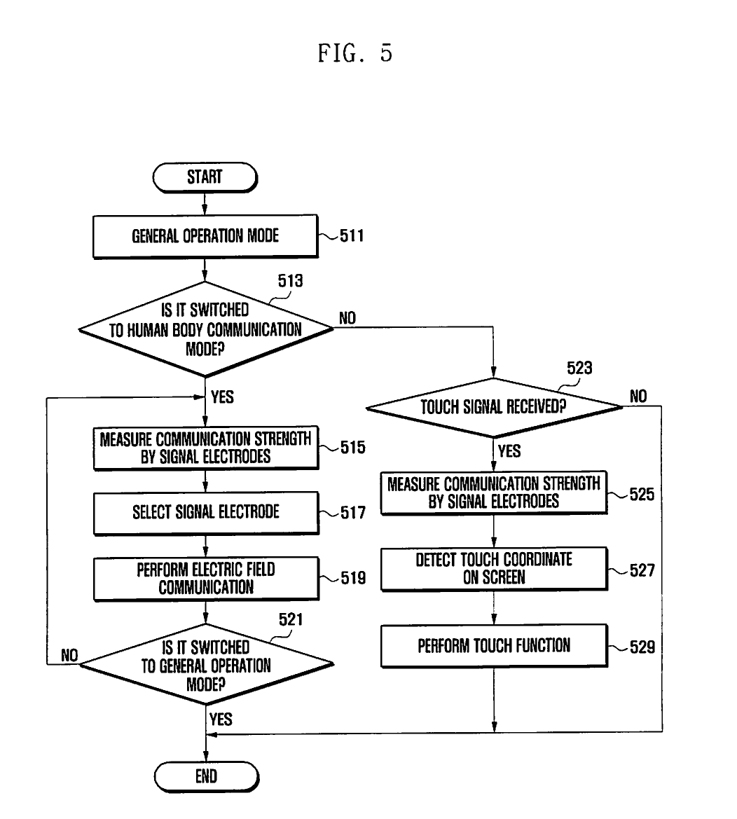

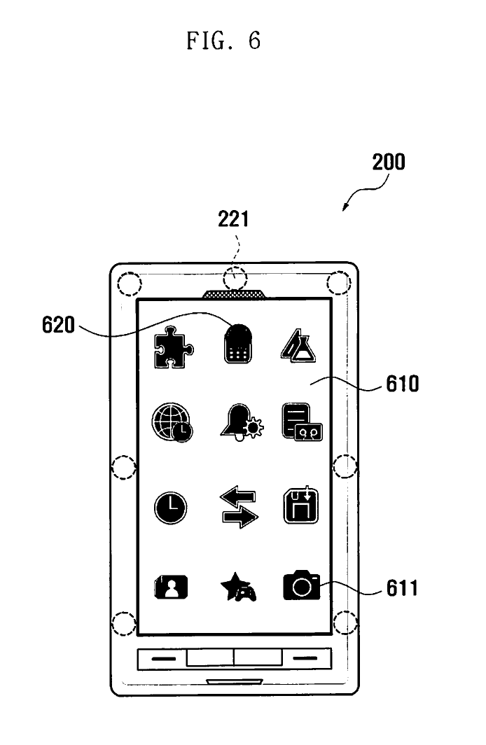

FIG. 5 describes a method for operating a communication terminal, according to an embodiment of the present invention. FIG. 6 illustrates a communication terminal in order to explain the method for operating the communication according to an embodiment of the present invention.

Referring to FIG. 5, the communication terminal 200 is operated as follows. The controller 240 is operated in a general operation mode in step 511. As shown in FIG. 6, the controller 240 displays at least one or more icons 611 on a screen 610. The icons 611 are used to activate corresponding functions, for example, a camera function, and a Motion Pictures Experts Group-Layer Audio 3 (MP3) player function.

After that, the controller 240 determines whether the general operation mode is switched to a human body communication mode in step 513. If the controller 240 ascertains that the general operation mode is switched to a human body communication mode at 513, it measures the communication strength of the signal electrodes 221 in step 515. If the electric field communication unit 220 is configured as shown in FIG. 4A, the controller 240 connects the switch 223 to the signal electrodes 221 according to the time slots, at a preset frame period, and measures the communication strength. That is, the controller 240 sequentially connects the switch 223 to the signal electrodes 221 for a period of time and measures the communication strength of the signal electrodes 221. Likewise, if the electric field communication unit 220 is configured as shown in FIG. 4B, the controller 240 measures the communication strength of the signal electrodes 221, and may make the measurement exclusive the resistance of the signal electrodes 221, according to the communication strength.

The controller 240 selects one of the signal electrodes 221 in step 517), compares the communication strength of the signal electrodes 221, and selects one from among the signal electrodes 221, which has the highest communication strength, as an optimum signal electrode. After that, the controller 240 optimally performs electric field communication using the selected signal electrode with the highest communication strength in step 519.

The controller 240 determines whether the human body communication mode is switched to the general operation mode in step 521. If the controller 240 ascertains that the human body communication mode is switched to the general operation mode at step 521, it terminates the human body communication mode. If the controller 240 ascertains that the human body communication mode is not switched to the general operation mode at step 521, it repeats steps 515 to 521 until the human body communication mode is switched to the general operation mode.

If the controller 240 receives a touch signal via at least one of the signal electrodes 221 in the general operation mode at step 511, it detects the touch signal in step 523, and measures the communication strength of the signal electrodes 221 in step 525. The touch signal has communication strength with a magnitude that is between a minimum and maximum threshold, such that the controller 240 determines that the electric field communication unit 220 touches the human body 300.

If the electric field communication unit 220 is configured as shown in FIG. 4A, the controller 240 connects the switch 223 to the signal electrodes 221 according to the time slots, at a preset frame period, and measures the communication strength. That is, the controller 240 sequentially connects the switch 223 to the signal electrodes 221 for a period of time and measures the communication strength of the signal electrodes 221. Likewise, if the electric field communication unit 220 is configured as shown in FIG. 4B, the controller 240 measures the communication strength of the signal electrodes 221. The controller 240 can measure the communication strength according to the respective resistances of the signal electrodes 221.

After that, the controller 240 detects a touch coordinate 620 on the screen 610 in step 527, as shown in FIG. 6. During this process, the controller 240 also analyzes the communication strength of the signal electrodes 221. The controller 240 can select at least three of the signal electrodes 221 according to the communication strength of the signal electrodes 221, i.e., in descending order from the highest communication strength to the lowest communication strength. The controller 240 can calculate the touch coordinate 620 on the screen 610 in trigonometry, by identifying the positions of the signal electrodes 221. If the electric field communication unit 220 is configured as shown in FIG. 4A, the controller 240 can identify the positions of the signal electrodes 221 according to the time slots.

Likewise, if the electric field communication unit 220 is configured as shown in FIG. 4B, the controller 240 can identify the positions of the signal electrodes 221 according to the communication strength. To this end, the controller 240 can previously set the ranges of communication strength where the signal electrodes 221 can be detected. The controller 240 can calculate the distance between the touch coordinate 620 and the signal electrodes 221 according to the communication strength. In addition, the touch coordinate detecting unit 245 can detect the touch coordinate in a range where the distances between the touch coordinate 620 and the signal electrodes 221 are overlapped.

After detecting the coordinate at step 527, the controller 240 operates a touch function on the touch coordinate 620 in step 529. That is, the controller 240 detects the icon at the touch coordinate 620 on the screen 610 and operates the touch function allocated to the icon 611. The memory 230 stores the position of the screen 610 on which the icon 611 is displayed, and the controller 240 compares the position of the icon 611 with the touch coordinate 620. The controller 240 selects the icon 611 corresponding to the touch coordinate and operates the touch function of the icon 611.

As described above, since the communication terminal according to the present invention includes a plurality of signal electrodes, it can perform electric field communication without contacting the user's body, which is a convenience to the user. In addition, since the plurality of signal electrodes can serve as an input unit, such as a touch screen, the user can efficiently use the communication terminal.

Although embodiments of the present invention have been described in detail hereinabove, it should be understood that many variations and modifications of the basic inventive concept herein described, which may be apparent to those skilled in the art, will still fall within the spirit and scope of the exemplary embodiments of the present invention as defined in the appended claims.

What is claimed is:

1. A method for operating a communication terminal, comprising:
measuring, when a touch occurs on a screen in a general operation mode, the communication strength of a plurality of signal electrodes located at an area around the screen to perform electric field communication;
analyzing the measured communication strength and detecting a touch coordinate on the screen; and
performing a touch function of the detected touch coordinate on the screen.

2. The method of claim 1, wherein detecting a touch coordinate comprises:
selecting at least three of the plurality of signal electrodes according to the measured communication strength; and
comparing positions of the selected signal electrodes based on the communication strength and detecting the touch coordinate.

3. The method of claim 1, wherein the signal electrodes include a transmitting electrode for signal transmission and a receiving electrode for signal reception, and measuring communication strength includes detecting the received signal via the receiving electrode.

4. The method of claim 1, further comprising:
switching the general operation mode to a human body communication mode;
measuring the communication strength of the signal electrodes; and
performing human body communication via one of the plurality of signal electrodes, which has a highest communication strength of the plurality of signal electrodes.

5. The method of claim 2, wherein the communication strength is measured based on a frame that includes a plurality of time slots and is allocated to the signal electrodes, and detecting a touch coordinate includes identifying a position of the selected signal electrode according to the time slots.

6. The method of claim 2, wherein the signal electrodes have different resistances, and detecting a touch coordinate includes identifying the position of the selected signal electrode according to a result generated as the resistance is applied to the measured communication strength.

7. A communication terminal comprising:
a display unit for displaying a screen;
a plurality of signal electrodes, located at an area around the screen, for performing electric field communication;
a communication strength measuring unit for measuring the communication strength of the signal electrodes when a touch is detected on the screen in a general operation mode;
a touch coordinate detecting unit for analyzing the measured communication strength and detecting a touch coordinate on the screen; and
a controller for performing a touch function of the detected touch coordinate on the screen.

8. The communication terminal of claim 7, further comprising:
a signal electrode selecting unit for selecting at least three of the plurality of signal electrodes according to the measured communication strength,
wherein the touch coordinate detecting unit compares positions of the selected signal electrodes based on the communication strength and detects the touch coordinate.

9. The communication terminal of claim 7, wherein:
the signal electrodes include a transmitting electrode for signal transmission and a receiving electrode for signal reception; and
the communication strength measuring unit measures communication strength when the received signal is detected via the receiving electrode.

10. The communication terminal of claim 7, wherein:
the communication strength measuring unit measures the communication strength of the signal electrodes when the general operation mode is switched to a human body communication mode; and
the controller performs human body communication via one of the plurality of signal electrodes that has a highest communication strength among the plurality of signal electrodes.

11. The communication terminal of claim 8, wherein:
the communication strength measuring unit measures the communication strength of the signal electrodes, based on a frame that includes a plurality of time slots and allocated to the signal electrodes; and
the touch coordinate detecting unit identifies the position of the selected signal electrode according to the time slots.

12. The communication terminal of claim 8, wherein:
the signal electrodes have different resistances; and
the touch coordinate detecting unit identifies the position of the selected signal electrode according to a result generated as the resistance is applied to the measured communication strength.
